(19) United States
(12) Patent Application Publication
(10) Pub. No.: US 2022/0321829 A1
(43) Pub. Date: Oct. 6, 2022

(54) CAPTURE SYSTEM

(71) Applicant: SUBARU CORPORATION, Tokyo (JP)

(72) Inventor: Nobutaka ASAHI, Tokyo (JP)

(21) Appl. No.: 17/835,523

(22) Filed: Jun. 8, 2022

Related U.S. Application Data
(63) Continuation of application No. PCT/JP2021/013929, filed on Mar. 31, 2021.

(51) Int. Cl. H04N 5/91; H04N 7/18; G01C 21/36

(52) U.S. Cl. CPC H04N 5/91; H04N 7/183; G01C 21/3647

(57) ABSTRACT

A capture system includes a control device capable of capturing an image of an environment outside a vehicle as a moving image and coupled to an image capturing device mounted on the vehicle in a wired or wireless manner, a user interface, and a display device. The control device includes at least one processor and at least one memory coupled to the at least one processor. The processor is configured to perform a process including acquiring an input specifying a predetermined timing; displaying, on the display device, a second moving image obtained by cutting out a moving image associated with a time period defined by the predetermined timing and a predetermined time from a first moving image captured by the image capturing device; acquiring an input specifying a predetermined time point in the time period; and generating a still image at the specified predetermined time point from the second moving image.

### CROSS REFERENCES TO RELATED APPLICATIONS

This application is continuation of International Application No. PCT/JP2021/013929, filed on Mar. 31, 2021, the entire contents of which are hereby incorporated by reference.

### BACKGROUND

### 1. Technical Field The disclosure relates to a capture system.

### 2. Related Art

For example, Japanese Unexamined Patent Application Publication No. 2013-32949 discloses a technique for displaying, with a bar, an image capturing period from the start to the end of capturing of landscape images continuously captured by an onboard camera. In such a technique, a landscape image at an image capturing time indicated by a slider with which a user is capable of indicating a position on the bar is displayed on a display device.

### SUMMARY

An aspect of the disclosure provides a capture system including a control device, a user interface, and a display device. The control device is capable of capturing an image of an environment outside a vehicle as a moving image and is coupled to an image capturing device mounted on the vehicle in a wired or wireless manner. The image capturing device is configured to capture a first moving image. The control device includes at least one processor and at least one memory coupled to the at least one processor. The at least one processor is configured to perform, in cooperation with a program stored in the at least one memory, a process including acquiring, through the user interface, an input specifying a predetermined timing; displaying, on the display device, a second moving image obtained by cutting out a moving image associated with a time period defined by the predetermined timing and a predetermined time from a first moving image captured by the image capturing device; acquiring, through the user interface, an input specifying a predetermined time point in the time period; and generating a still image at the specified predetermined time point from the second moving image.

An aspect of the disclosure provides a vehicle including the above-described capture system and image capturing device.

### BRIEF DESCRIPTION OF THE DRAWINGS

FIG. 1 is a block diagram illustrating a configuration of a capture system according to a first embodiment;

FIG. 2 is a perspective side view illustrating an example of a vehicle;

FIG. 3 illustrates an example of the interior of the vehicle;

FIG. 4 is a block diagram illustrating a function of a control device;

FIG. 5 is a flowchart illustrating a flow of the operation of a drive recorder;

FIG. 6 is a flowchart illustrating the relationship between the operation of the control device and the action of an occupant;

FIG. 7 is a flowchart illustrating the relationship between the operation of the control device and the action of the occupant;

FIG. 8 is a block diagram illustrating a configuration of a capture system according to a second embodiment; and

FIG. 9 is a block diagram illustrating a configuration of a capture system according to a third embodiment.

### DETAILED DESCRIPTION

In some cases, an occupant of a vehicle during traveling finds objects, landscapes, animals, plants, or the like that interest the occupant outside the vehicle. If the occupant is other than a driver, the occupant may attempt to take a photograph of the found object or the like. However, since the vehicle is traveling, the vehicle moves away from the position of the found object or the like. This may prevent the occupant from taking an intended photograph. If the occupant is a driver, it is impossible to take a photograph. For this reason, it is desirable that an image of an object or the like that interests the occupant outside the vehicle can be recorded as data.

Accordingly, it is desirable to provide a capture system capable of recording, as data, an image of an object or the like that interests the occupant outside the vehicle.

Hereinafter, embodiments of the disclosure will be described in detail with reference to the attached drawings. The specific dimensions, materials, numerical values, and the like shown in the embodiments are merely examples for facilitating understanding of the disclosure, and do not limit the disclosure unless otherwise specified. In this specification and the drawings, elements having substantially the same function and configuration are denoted by the same reference numeral to omit redundant description thereof. Furthermore, elements not directly related to the disclosure are not illustrated.

### FIRST EMBODIMENT

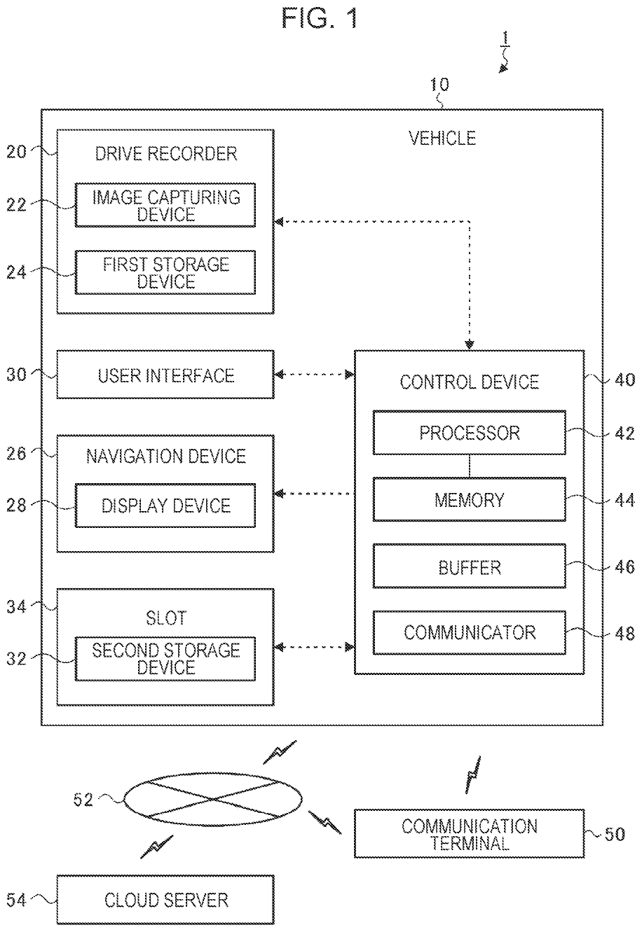

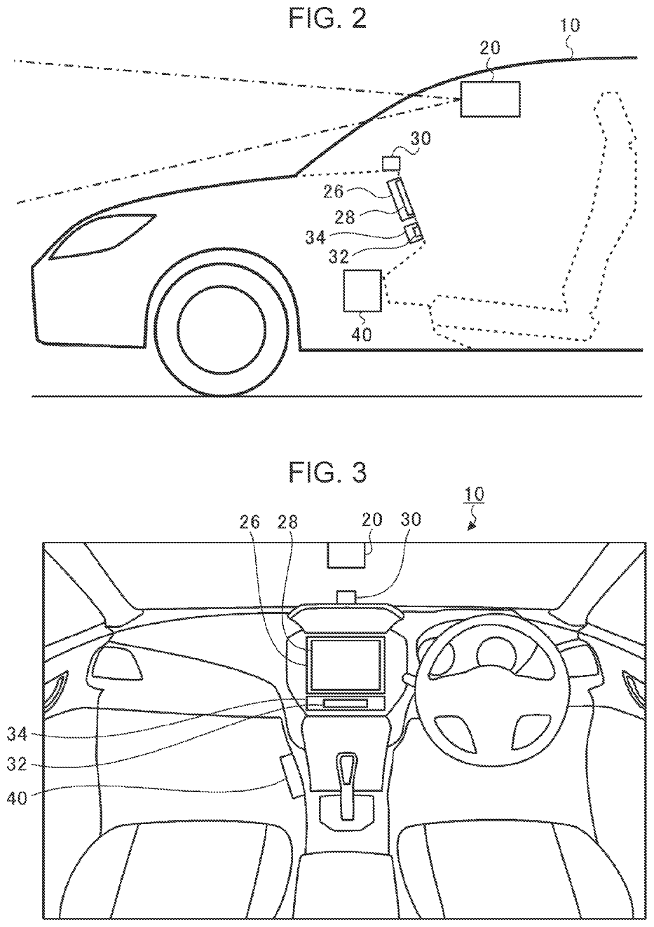

FIG. 1 is a block diagram illustrating a configuration of a capture system 1 according to a first embodiment. The capture system 1 is applied to a vehicle 10. The vehicle 10 is, for example, an internal combustion engine vehicle, an electric vehicle, or a hybrid vehicle. FIG. 2 is a perspective side view illustrating an example of the vehicle 10. FIG. 3 illustrates an example of the interior of the vehicle 10. Hereinafter, each element of the capture system 1 will be described with reference to FIGS. 1 to 3.

A drive recorder 20 is mounted on the vehicle 10. The drive recorder 20 is disposed, for example, so as to be able to capture an image in front of the vehicle 10 from the vehicle cabin through the windshield. The drive recorder 20 includes an image capturing device 22 and a first storage device 24. The image capturing device 22 is capable of capturing an image of an environment outside the vehicle as a moving image. The image capturing device 22 is disposed such that image capturing direction is a front direction of the vehicle 10.

The first storage device 24 stores a moving image captured by the image capturing device 22 in association with the time at which the moving image is captured. The first storage device 24 has a predetermined storage capacity. The predetermined storage capacity is, for example, a capacity capable of storing a moving image of 10 minutes. Note that the storage capacity is not limited to the exemplified capacity and may be a capacity capable of storing a moving image of any time length. The first storage device 24 continuously stores the captured moving image at all times. When the data capacity of the stored moving image reaches the storage capacity of the first storage device 24, the first storage device 24 deletes the oldest data of the stored moving image and stores the latest data.

The capture system 1 includes a navigation device 26. The navigation device 26 is mounted on the vehicle 10. The navigation device 26 is disposed, for example, in a region of an instrument panel facing a space between a driver's seat and a front passenger seat.

The navigation device 26 includes a display device 28. The display device 28 can display a map for navigation. As will be described later, the display device 28 can display a part of the moving image acquired by the image capturing device 22 of the drive recorder 20.

The capture system 1 includes a user interface 30. The user interface 30 is mounted on the vehicle 10. The user interface 30 is disposed, for example, above the navigation device 26. The user interface 30 includes a microphone and a speaker. The user interface 30 receives a voice input from an occupant of the vehicle 10. Furthermore, the user interface 30 outputs voice to the occupant. The occupant is not limited to the driver, and includes a person other than the driver who occupies a seat such as a front passenger seat or a rear passenger seat.

The capture system 1 includes a second storage device 32. The second storage device 32 is, for example, a flash memory such as an SD memory card. The vehicle 10 includes a slot 34 capable of accommodating the second storage device 32. The slot 34 is disposed, for example, below the navigation device 26. The second storage device 32 can store data while being accommodated in the slot 34. The second storage device 32 can be taken out from the slot 34.

The capture system 1 includes a control device 40. The control device 40 is mounted on the vehicle 10. The control device 40 is disposed, for example, below the slot 34 and near the front passenger seat.

The control device 40 includes at least one processor 42 and at least one memory 44 coupled to the at least one processor 42. The memory 44 includes a ROM storing programs and the like and a RAM serving as a work area. The processor 42 of the control device 40 controls the whole of the capture system 1 in cooperation with a program stored in the memory 44. The control device 40 is coupled to the drive recorder 20 in a wired or wireless manner. The operation of the control device 40 will be described in detail later.

The control device 40 includes a buffer 46. The buffer 46 can temporarily store a part of the moving image stored in the first storage device 24.

In some cases, an occupant of the vehicle 10 during traveling finds objects, landscapes, animals, plants, or the like that interest the occupant outside the vehicle. If the occupant is other than a driver, the occupant may attempt to take a photograph of the found object or the like. However, since the vehicle 10 is traveling, the vehicle 10 moves away from the position of the found object or the like. This may prevent the occupant from taking an intended photograph. If the occupant is the driver, it is impossible to take a photograph. For this reason, it is desirable that an image of an object or the like that interests the occupant outside the vehicle can be recorded as data.

Therefore, in the capture system 1, when the vehicle 10 moves away from the position of the found object or the like, the occupant performs an input specifying a predetermined timing and a predetermined time on the user interface 30.

The predetermined timing is, for example, a timing at which the occupant performs the input to the user interface 30. The predetermined time indicates, for example, a time going back to the past from the predetermined timing. That is, the occupant specifies the predetermined timing and the predetermined time so that the time period defined by the predetermined timing and the predetermined time includes a time point at which the object or the like has been found. For example, the occupant inputs “show a moving image for two minutes before now” to the user interface 30 by voice. In this example, the predetermined timing is “now”. The predetermined time is “two minutes”.

The processor 42 of the control device 40 can acquire, through the user interface 30, an input specifying the predetermined timing and the predetermined time.

The processor 42 of the control device 40 performs a process for displaying, on the display device 28, a second moving image obtained by cutting out a moving image captured in a time period defined by the predetermined timing and the predetermined time from a first moving image captured by the image capturing device 22.

In one example, the control device 40 acquires, from the first storage device 24, the second moving image which is captured in the time period defined by the predetermined timing and the predetermined time and which is a part of the first moving image stored in the first storage device 24. The control device 40 stores the acquired second moving image associated with the time period in the buffer 46 and displays the second moving image on the display device 28. Alternatively, the control device 40 stores, in the buffer 46, the first moving image stored in the first storage device 24 in response to the input of the predetermined timing and the predetermined time. Thereafter, the control device 40 cuts out the second moving image captured in the time period from the first moving image stored in the buffer 46. The control device 40 may store the cut out second moving image in the buffer 46 and display the second moving image on the display device 28.

The occupant watches the displayed moving image in the time period and searches for a part where the intended object or the like is displayed. When the occupant finds the object or the like from the moving image in the time period, the occupant specifies a predetermined time point at which the object or the like is displayed in the time period.

The processor 42 of the control device 40 can acquire, through the user interface 30, an input specifying the predetermined time point in the time period.

The processor 42 of the control device 40 performs a process for generating a still image at the specified predetermined time point from the second moving image in the time period. The control device 40 displays the generated still image on the display device 28.

According to the capture system 1, since a still image at a predetermined time point specified by the occupant is generated, it is possible to record, as data, an image of an object or the like that interests the occupant outside the vehicle. The occupant can also visually recognize the object or the like again by viewing the generated still image at the predetermined time point later.

The occupant may freely change the predetermined time to be input to, for example, “show a moving image for one minute before now” or “show a moving image for three minutes before now”. That is, the predetermined time is not limited to a fixed time, and may be specified using a freely selected time.

The predetermined timing is not limited to a timing at which the occupant performs an input to the user interface 30. The predetermined timing may be any timing earlier than the timing at which the occupant performs an input to the user interface 30. For example, the occupant may perform an input such as “show a moving image for two minutes before the time point of one minute ago”. When the predetermined timing is any timing in the past, the method of specifying the predetermined timing is not limited to a method of relatively specifying a timing based on the current time, and may be a method of specifying an absolute time. For example, the occupant may perform an input such as “show a moving image up to 2 minutes ago from 9:00”.

The predetermined timing is not limited to a timing corresponding to an end time in the time period defined by the predetermined timing and the predetermined time. The predetermined timing may be specified so as to correspond to a start time in the time period. For example, the occupant may perform an input such as “show a moving image for two minutes after the time point of three minutes ago”. The predetermined timing may also be specified so as to correspond to a time at the center of the time period. For example, the occupant may perform an input such as “show a moving image for two minutes before and after the time point of two minutes ago”.

The occupant may specify the predetermined timing without specifying the predetermined time. In this case, the control device 40 may interpret that a time set in advance is specified as the predetermined time. For example, assume that the occupant performs an input “show a moving image at 9:00”, and the predetermined time set in advance is 10 minutes. In this example, the control device 40 may cause the display device 28 to display a moving image in a time period from 8:55 to 9:05.

In this manner, the occupant can specify the predetermined timing and the predetermined time by various methods. Therefore, the control device 40 can cause the display device 28 to display a moving image in an appropriate time period intended by the occupant. As a result, the control device 40 can reduce the effort of the occupant to specify the predetermined time point.

If the occupant who has found an object or the like that interests the occupant is a person other than the driver, it is possible to check the moving image in the time period while the vehicle 10 is traveling. Therefore, the control device 40 can generate a still image desired by the occupant without delay while the vehicle 10 is traveling.

If the occupant who has found an object or the like that interests the occupant is a driver, the occupant may perform an input specifying the predetermined timing and the predetermined time after the vehicle 10 moves away from the position of the object or the like and the traveling of the vehicle 10 is stopped. In this case, the occupant may memorize an approximate time at which the object or the like has been found, and may specify the predetermined timing and the predetermined time so that the remembered time is included in the time period.

The control device 40 includes a communicator 48. The communicator 48 can perform short-range wireless communication such as Bluetooth with one or more communication terminals 50. The one or more communication terminals 50 are, for example, one or more smartphones and one or more tablet terminals. The control device 40 can transmit a still image to the one or more communication terminals 50 by short-range wireless communication.

The communicator 48 can be coupled to a network 52 such as the Internet or a telephone network. The one or more communication terminals 50 can also be coupled to the network 52. The control device 40 can also transmit a still image to the communication terminals 50 via the network 52.

That is, the processor 42 of the control device 40 can transmit the generated still image at the predetermined time point to the one or more communication terminals 50 capable of communicating with the control device 40. When the still image is transmitted to the one or more communication terminals 50, the occupant can visually recognize the still image through a display device of the one or more communication terminals 50.

A cloud server 54 can be coupled to the network 52. The control device 40 can transmit the still image to the cloud server 54 coupled to the network 52. When the still image is transmitted to the cloud server 54, the occupant can download the still image from the cloud server 54 to, for example, a personal computer of the occupant and can visually recognize the still image.

The control device 40 can also store the generated still image in the second storage device 32. When the still image is stored in the second storage device 32, the occupant can take out the second storage device 32 from the slot 34 and visually recognize the still image in another apparatus capable of reading the second storage device 32.

After transmission of the still image, the control device 40 may delete the moving image and the still image in the time period stored in the buffer 46.

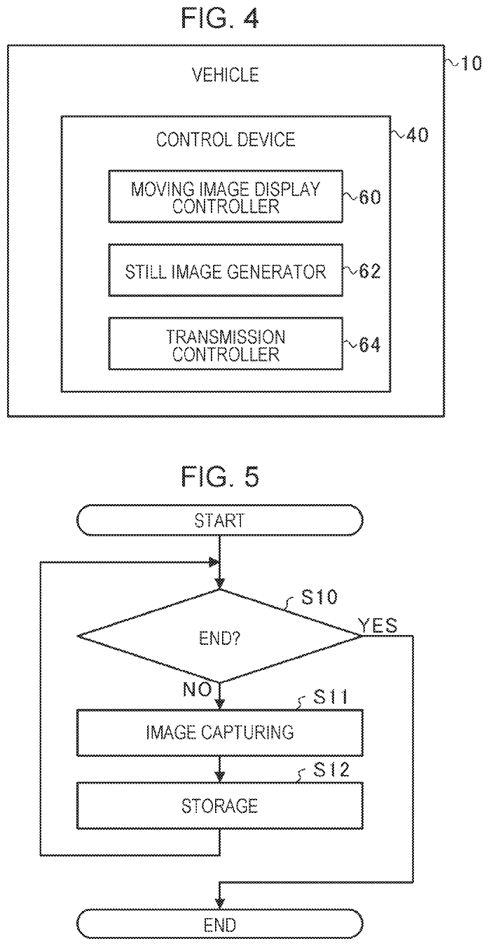

FIG. 4 is a block diagram illustrating a function of the control device 40. The processor 42 of the control device 40 functions as a moving image display controller 60, a still image generator 62, and a transmission controller 64 in cooperation with a program included in the memory 44.

The moving image display controller 60 acquires, through the user interface 30, an input specifying a predetermined timing and a predetermined time. The first storage device 24 continuously stores a moving image captured by the image capturing device 22 at all times. The moving image display controller 60 acquires, from the first storage device 24, a moving image that is captured in a time period defined by the predetermined timing and the predetermined time and that is included in the moving image stored in the first storage device 24. The moving image display controller 60 displays the acquired moving image associated with the time period on the display device 28. The moving image display controller 60 may acquire the moving image stored in the first storage device 24 in response to the input of the predetermined timing and the predetermined time. Thereafter, the moving image display controller 60 may cut out a moving image captured in the time period from the acquired moving image and display the cut out moving image on the display device 28.

The still image generator 62 acquires, through the user interface 30, an input specifying a predetermined time point in the time period. The still image generator 62 generates a still image at the specified predetermined time point from the moving image in the time period. The still image generator 62 displays the generated still image on the display device 28.

The transmission controller 64 transmits the generated still image at the predetermined time point to the one or more communication terminals 50 capable of communicating with the control device 40. The transmission controller 64 may transmit the generated still image at the predetermined time point to the cloud server 54. The transmission controller 64 may store the generated still image at the predetermined time point in the second storage device 32.

FIG. 5 is a flowchart illustrating a flow of the operation of the drive recorder 20. When the ignition of the vehicle 10 is turned on (IG-ON), the drive recorder 20 starts a series of processes in FIG. 5. If the predetermined end condition is not satisfied (NO in S10), the drive recorder 20 repeats capturing a moving image (S11) and storing the moving image in the first storage device 24 (S12). The predetermined end condition is, for example, that the ignition of the vehicle 10 is turned off (IG-OFF), but is not limited to this example and can be freely set. When the predetermined end condition is satisfied (YES in S10), the drive recorder 20 ends the series of processes.

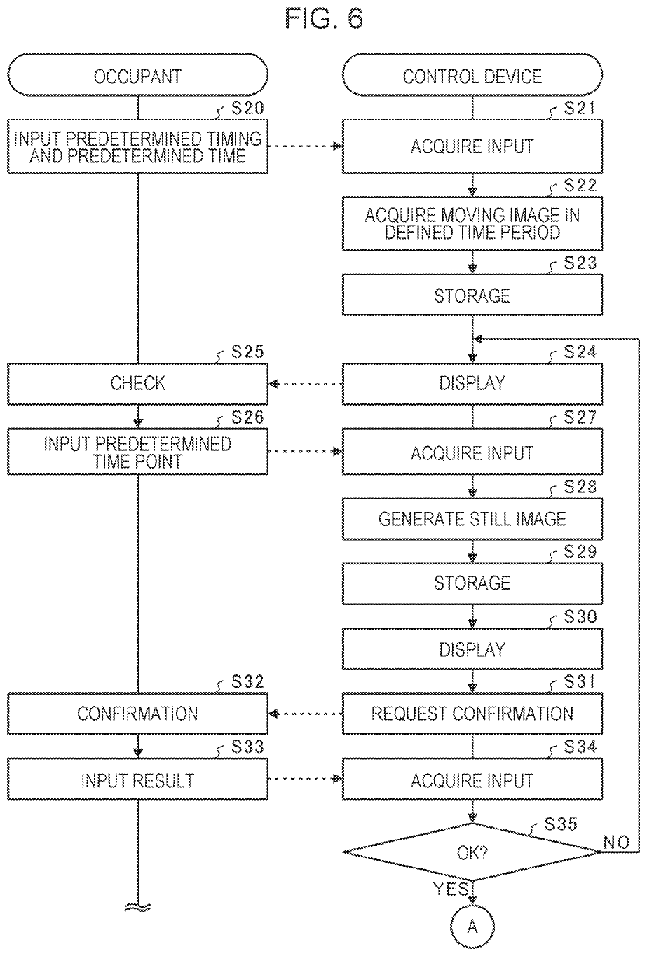

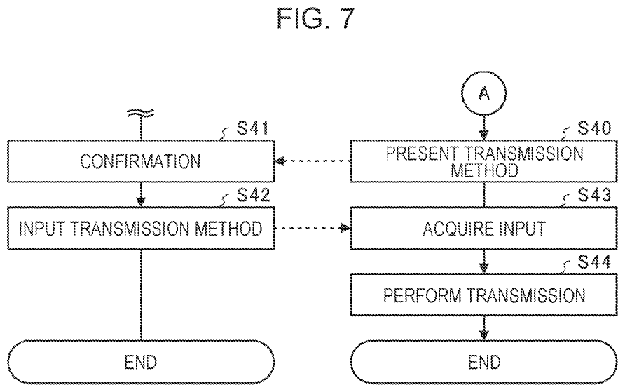

FIGS. 6 and 7 are flowcharts illustrating the relationship between the operation of the control device 40 and the action of the occupant. “A” in FIG. 6 is linked to “A” in FIG. 7.

As illustrated in FIG. 6, when the occupant finds an object or the like that interests the occupant, the occupant performs an input specifying a predetermined timing and a predetermined time (S20). For example, the occupant inputs “show a moving image for two minutes before now” to the user interface 30 by voice.

When the input in step S20 is performed, the moving image display controller 60 of the control device 40 acquires, through the user interface 30, the input specifying the predetermined timing and the predetermined time (S21). Next, the moving image display controller 60 acquires a moving image captured in a time period defined by the predetermined timing and the predetermined time from the first storage device 24 of the drive recorder 20 (S22). The moving image display controller 60 stores the acquired moving image in the time period in the buffer 46 (S23). Next, the moving image display controller 60 transmits the acquired moving image in the time period to the navigation device 26 and displays the moving image in the time period on the display device 28 (S24).

When the moving image in the time period is displayed on the display device 28, the occupant checks the displayed moving image (S25). When the occupant finds an intended object or the like in the displayed moving image, the occupant performs an input specifying a predetermined time point at which the object or the like is displayed (S26). For example, the occupant inputs “That point” to the user interface 30 by voice.

When the input in step S26 is performed, the still image generator 62 of the control device 40 acquires, through the user interface 30, the input specifying the predetermined time point (S27). Next, the still image generator 62 temporarily stops the moving image displayed on the display device 28 in response to the input specifying the predetermined time point. Then, the control device 40 generates, as a still image, an image displayed while being temporarily stopped (S28).

The still image generator 62 stores the generated still image in the buffer 46 (S29). Next, the still image generator 62 displays the generated still image on the display device 28 (S30). Next, the still image generator 62 requests the occupant to confirm the content of the still image (S31). For example, the still image generator 62 outputs a voice such as “Do you want this image?” through the user interface 30.

When the confirmation request is output through the user interface 30, the occupant confirms the content of the still image displayed on the display device 28 (S32). After the confirmation, the occupant inputs a confirmation result (S33). For example, the occupant inputs “OK” to the user interface 30 by voice. When the still image is not an intended image, the occupant may perform an input for executing generation of a still image again.

When the input in step S33 is performed, the still image generator 62 acquires the input of the confirmation result through the user interface 30 (S34). If the acquired confirmation result is positive (YES in S35), the still image generator 62 performs a process in step S40 in FIG. 7. If the acquired result is negative (NO in S35), the still image generator 62 resumes the display of the temporarily stopped moving image and repeats the processes after step S25.

As illustrated in FIG. 7, in step S40, the transmission controller 64 of the control device 40 inquires about a transmission method (S40). For example, the transmission controller 64 outputs a voice such as “Specify an image transmission method” through the user interface 30. Alternatively, the transmission controller 64 may present specific transmission methods. For example, the transmission controller 64 may outputs a voice such as “transmission to the communication terminals 50 via Bluetooth, transmission to the communication terminals 50 by e-mail, transmission to the cloud server 54, or storage in a flash memory is possible”.

When the presentation of the transmission method is output through the user interface 30, the occupant confirms the transmission method (S41). After the confirmation, the occupant inputs a desired transmission method (S42). For example, the occupant performs an input such as “transmission via Bluetooth” to the user interface 30 by voice.

When the input in step S42 is performed, the transmission controller 64 acquires the input of the transmission method through the user interface 30 (S43). Next, the transmission controller 64 transmits the still image generated in step S28 in accordance with the transmission method acquired in step S43 (S44), and ends the series of processes.

When transmission via Bluetooth is specified, the transmission controller 64 turns on the Bluetooth function in the communicator 48. The transmission controller 64 displays a list of communication terminals present within a communicable range on the display device 28. The occupant performs an input to select one or more of the communication terminals as the one or more communication terminals 50 of the occupant from the displayed list. The control device 40 transmits the still image to the selected one or more communication terminals as the one or more communication terminals 50 via Bluetooth.

When transmission by e-mail is specified, the transmission controller 64 transmits the still image to an e-mail address registered in advance through the network 52. The control device 40 may prompt the occupant to input an e-mail address of the recipient through the user interface 30.

When transmission to the cloud server 54 is specified, the transmission controller 64 transmits the still image to the cloud server 54 registered in advance through the network 52. The occupant can download the still image transmitted to the cloud server 54 to, for example, a personal computer of the occupant.

When storage in a flash memory is specified, the transmission controller 64 stores the still image in the second storage device 32. The occupant may take out the second storage device 32 from the slot 34 of the vehicle 10. When the second storage device 32 is housed in another apparatus capable of reading the second storage device 32, the occupant can visually recognize the still image through a display device of the apparatus in which the second storage device 32 has been housed.

As described above, in the capture system 1 according to the first embodiment, a moving image in a time period defined by an input of a predetermined timing and a predetermined time in the moving image captured by the image capturing device 22 is displayed on the display device 28. In the capture system 1 of the first embodiment, then, a still image at a predetermined time point specified by the occupant is generated from the moving image in the time period.

Therefore, according to the capture system 1 of the first embodiment, it is possible to record, as data, an image of an object or the like that interests the occupant outside the vehicle.

In one comparative example, a plurality of still images are automatically generated from a moving image captured by the image capturing device 22 on the basis of, for example, landmarks. In this comparative example, the number of generated still images is large, which increases a burden of searching for a desired still image from the plurality of generated still images. In this comparative example, since still images are automatically generated, it is not possible to appropriately acquire a still image of an object or the like that has been accidentally found.

On the other hand, in the capture system 1 of the first embodiment, a moving image in a time period specified by the occupant is cut out from a captured moving image. Then, the occupant searches for a part where the intended object or the like is displayed from the cut out moving image. For this reason, in the capture system 1 of the first embodiment, it is possible to reduce a burden of searching for an intended part. In the capture system 1 of the first embodiment, since a pinpoint still image at a predetermined time point intended by the occupant is generated, it is possible to avoid a burden of searching for a still image from a plurality of still images. In the capture system 1 of the first embodiment, since a still image at a predetermined time point specified by the occupant is generated, it is possible to acquire a still image intended by the occupant on the basis of the decision of the occupant. For this reason, in the capture system 1 of the first embodiment, it is possible to appropriately acquire a still image of an object or the like that has been accidentally found.

In the first embodiment, the image capturing device 22 and the first storage device 24 are disposed in the drive recorder 20, and the display device 28 is disposed in the navigation device 26. That is, the drive recorder 20 and the navigation device 26 that are generally mounted on the vehicle 10 can be used for the image capturing device 22, the first storage device 24, and the display device 28. Therefore, the capture system 1 according to the first embodiment can be easily introduced to the vehicle 10.

### SECOND EMBODIMENT

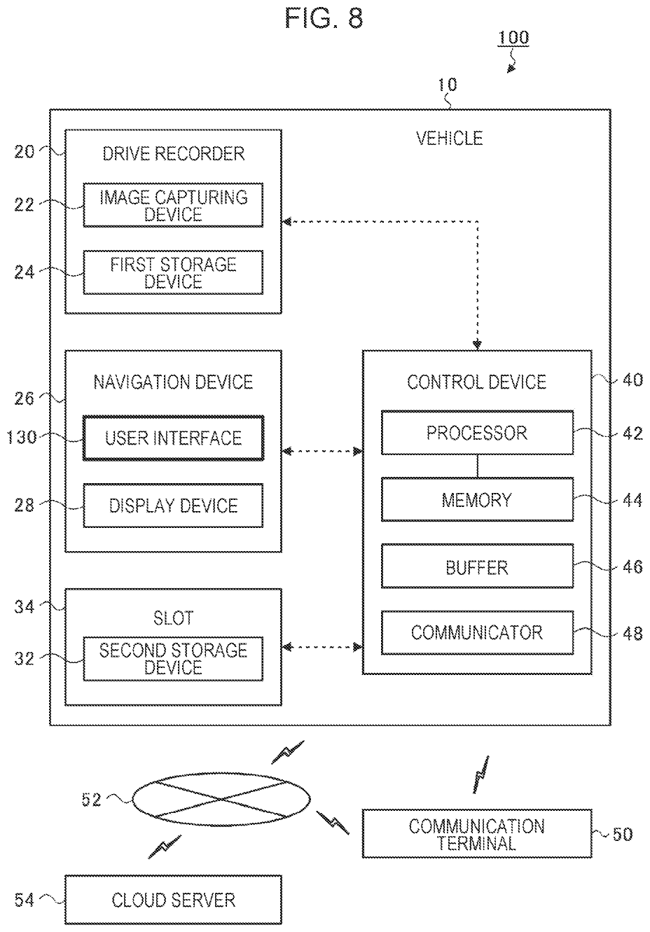

FIG. 8 is a block diagram illustrating a configuration of a capture system 100 according to a second embodiment. A user interface 130 of the capture system 100 is disposed in the navigation device 26. The capture system 100 has the same configuration as that of the capture system 1 of the first embodiment, except for the location at which the user interface 130 is disposed.

The user interface 130 is, for example, a touch panel disposed on the front face of the display device 28. The user interface 130 may also be various buttons or switches of the navigation device 26. For example, the occupant may input replay, pause, fast reverse, fast forward, or the like of a moving image displayed on the display device 28 through a touch panel, a button, a switch, or the like. The user interface 130 may be a microphone or a speaker built in the navigation device 26.

In the capture system 100 according to the second embodiment, as in the first embodiment, it is possible to record, as data, an image of an object or the like that interests the occupant outside the vehicle.

In the capture system 100 of the second embodiment, since the user interface 130 is disposed in the navigation device 26, the number of components mounted on the vehicle 10 can be reduced.

### THIRD EMBODIMENT

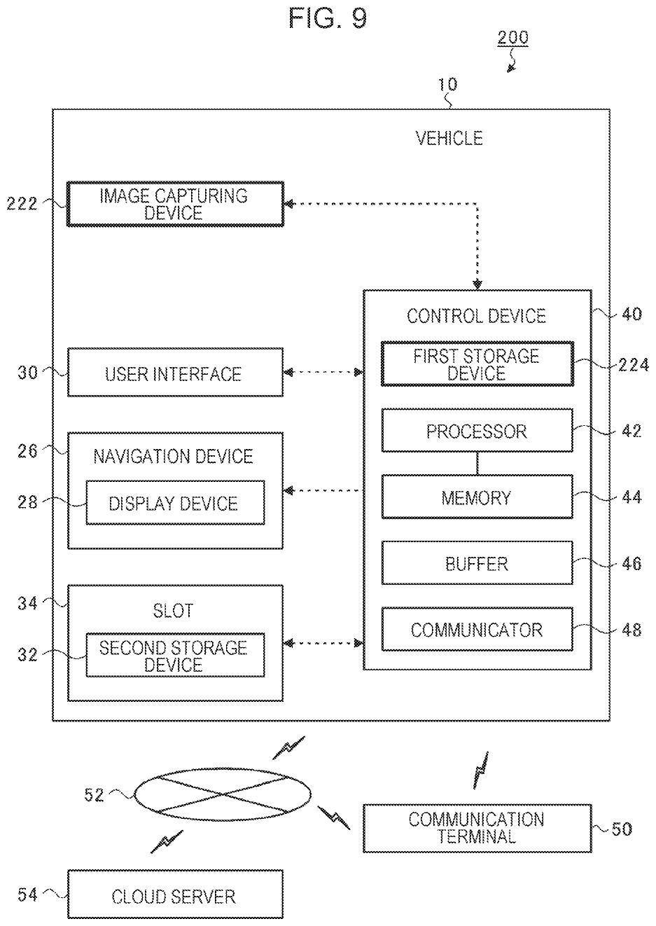

FIG. 9 is a block diagram illustrating a configuration of a capture system 200 according to a third embodiment. In the third embodiment, the drive recorder 20 is omitted. In the third embodiment, an image capturing device 222 is mounted on the vehicle 10. The image capturing device 222 is disposed, for example, so as to be able to capture an image in front of the vehicle 10 from the vehicle cabin through the windshield. The image capturing device 222 is capable of capturing an image of an environment outside the vehicle as a moving image. The image capturing device 222 is disposed such that image capturing is performed in a front direction of the vehicle 10. The image capturing device 222 may use, for example, an image capturing device of advanced driver-assistance systems (ADAS).

In the third embodiment, a first storage device 224 is built in the control device 40. The image capturing device 222 sequentially transmits a captured moving image to the control device 40. The first storage device 224 stores the moving image received from the image capturing device 222 in association with the reception time. When the data capacity of the stored moving image reaches the storage capacity of the first storage device 224, the first storage device 224 deletes the oldest data of the stored moving image and stores the latest data. The capture system 200 has the same configuration as that of the capture system 1 of the first embodiment, except that the image capturing device 222 and the first storage device 224 are separately disposed.

In the capture system 200 according to the third embodiment, as in the first embodiment, it is possible to record, as data, an image of an object or the like that interests the occupant outside the vehicle.

In the capture system 200 of the third embodiment, even if the drive recorder 20 itself is not disposed, the same function as that of the drive recorder 20 can be realized.

Although the embodiments of the disclosure have been described above with reference to the attached drawings, it is obvious that the disclosure is not limited to the above-described embodiments. It is clear that a person skilled in the art can conceive various modifications and alterations within the scope described in the claims. It is to be understood that these modifications and alterations are obviously included in the technical scope of the disclosure.

For example, all of the image capturing device 22, the first storage device 24, the display device 28, the user interface 30, and the control device 40 may be disposed in the same unit.

The control device 40 according to the first embodiment stores the cut out moving image and the generated still image in the buffer 46. However, the control device 40 may store the cut out moving image and the generated still image in the second storage device 32.

The features of the embodiments and the modifications may be combined as appropriate.

The control device 40 illustrated in FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 40 including the moving image display controller 60, the still image generator 62, and the transmission controller 64. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 4.

1. A capture system comprising:
a control device capable of capturing an image of an environment outside a vehicle as a moving image and coupled to an image capturing device mounted on the vehicle in a wired or wireless manner, the image capturing device being configured to capture a first moving image;
a user interface; and
a display device,
wherein the control device comprises:
at least one processor; and
at least one memory coupled to the at least one processor, and
wherein the at least one processor is configured to perform, in cooperation with a program stored in the at least one memory, a process comprising:
acquiring, through the user interface, an input specifying a predetermined timing;
displaying, on the display device, a second moving image obtained by cutting out a moving image associated with a time period defined by the predetermined timing and a predetermined time from a first moving image captured by the image capturing device;
acquiring, through the user interface, an input specifying a predetermined time point in the time period; and
generating a still image at the specified predetermined time point from the second moving image.

2. The capture system according to claim 1,
wherein the process further comprises acquiring, through the user interface, an input specifying the predetermined time.

3. The capture system according to claim 1,
wherein the process further comprises transmitting the generated still image to a predetermined communication terminal capable of communicating with the control device.

4. The capture system according to claim 1, wherein
the image capturing device is a drive recorder,
the display device is disposed in a navigation device of the vehicle, and
the process further comprises acquiring the second moving image from the drive recorder and transmitting the second moving image to the navigation device.

5. A vehicle comprising:
the capture system comprising the control device coupled to the image capturing device according to claim 1; and
the image capturing device.
